(19) United States
(12) Patent Application Publication
(10) Pub. No.: US 2025/0220575 A1
(43) Pub. Date: Jul. 3, 2025

(54) DATA TRANSMISSION CONTROL METHOD AND APPARATUS, ELECTRONIC DEVICE, AND STORAGE MEDIUM

(71) Applicant: Tencent Technology (Shenzhen) Company Limited, Shenzhen (CN)

(72) Inventors: Hao WANG, Shenzhen (CN); Xin Zuo, Shenzhen (CN)

(21) Appl. No.: 19/085,826

(22) Filed: Mar. 20, 2025

Related U.S. Application Data
(63) Continuation of application No. PCT/CN2023/130000, filed on Nov. 6, 2023.

(30) Foreign Application Priority Data
Feb. 24, 2023 (CN) 202310196090.5

(51) Int. Cl. H04W 52/02

(52) U.S. Cl. CPC H04W 52/0212

(57) ABSTRACT

A data transmission control method is performed by a computer device that is wirelessly connected to a wireless access point, and the method includes: transmitting, to the wireless access point, a request frame carrying a target wake time (TWT) parameter, the TWT parameter comprising an indicator parameter for instructing the wireless access point to schedule the computer device to perform data transmission within a target wake time service period (TWT SP); receiving a response frame returned by the wireless access point; and transmitting, when the response frame indicates that the wireless access point confirms the TWT parameter, a data packet to the wireless access point within the TWT SP.

### CROSS-REFERENCE TO RELATED APPLICATIONS

This application is a continuation application of PCT Patent Application No. PCT/CN2023/130000, entitled “DATA TRANSMISSION CONTROL METHOD AND APPARATUS, ELECTRONIC DEVICE, AND STORAGE MEDIUM” filed on Nov. 6, 2023, which claims the benefit of priority to Chinese patent application No. 202310196090.5, entitled “DATA TRANSMISSION CONTROL METHOD AND APPARATUS, ELECTRONIC DEVICE, AND STORAGE MEDIUM” filed on Feb. 24, 2023, all of which are incorporated in their entirety herein by reference.

### FIELD OF THE TECHNOLOGY

This application relates to the technical field of communication, and in particular to a data transmission control method, a data transmission control apparatus, an electronic device, and a computer-readable storage medium.

### BACKGROUND OF THE DISCLOSURE

As defined in the latest seventh-generation wireless fidelity (Wi-Fi) network (Wi-Fi 7) standard, data of a low-delay service has a maximum delay limit. If the data exceeds the maximum delay limit, the data will be deleted, causing an increase in a packet loss rate. Thus, a data packet of the low-delay service has timeliness. If no transmitting opportunity is obtained for a long time, the packet will be lost, resulting in a decrease in quality of service (QOS). Thus, how to prevent a data packet of a low-delay service from being lost due to a timeout is an urgent technical problem to be resolved.

### SUMMARY

Embodiments of this application provide a data transmission control method, a data transmission control apparatus, an electronic device, a computer-readable storage medium, and a computer program product respectively.

In a first aspect, an embodiment of this application provides a data transmission control method performed by a computer device wirelessly connected to a wireless access point. The method includes: transmitting, to the wireless access point, a request frame carrying a target wake time (TWT) parameter, the TWT parameter comprising an indicator parameter for instructing the wireless access point to schedule the computer device to perform data transmission within a target wake time service period (TWT SP); receiving a response frame returned by the wireless access point; and transmitting, when the response frame indicates that the wireless access point confirms the TWT parameter, a data packet to the wireless access point within the TWT SP.

In a second aspect, an embodiment of this application provides a data transmission control apparatus. The apparatus is applied to a wireless device connected to a wireless access point. The apparatus includes: a transmitting module configured to transmit a request frame carrying a TWT parameter to the wireless access point, the TWT parameter comprising an indicator parameter for instructing the wireless access point to schedule the computer device to perform data transmission within a target wake time service period (TWT SP); and a receiving module configured to receive a response frame returned by the wireless access point. The transmitting module is further configured to transmit, when the response frame indicates that the wireless access point confirms the TWT parameter, a data packet to the wireless access point within the TWT SP.

In a third aspect, an embodiment of this application provides a computer device. The computer device includes: one or more processors; and a memory configured to store one or more programs. The one or more computer programs cause the computer device to implement the data transmission control method mentioned above when executed by the one or more processors.

In a fourth aspect, an embodiment of this application provides a non-transitory computer-readable storage medium. The non-transitory computer-readable storage medium has a computer-readable instruction stored therein. The computer-readable instruction, when executed by a processor of a computer device, causes the computer to implement the data transmission control method mentioned above.

In a fifth aspect, an embodiment of this application provides a computer program product. The computer program product includes a computer program. When executed by a processor, the computer program implements operations of the data transmission control method mentioned above.

In technical solutions provided in embodiments of this application, a wireless device instructs, by using a signaling, a wireless access point to first schedule uplink data of the wireless device. That is, when a response frame received by the wireless device indicates that the wireless access point already confirms a TWT parameter carried in a request frame transmitted by the wireless device, the wireless access point already confirms that the wireless device is first scheduled within a TWT SP expected by the wireless device. Thus, the wireless device can transmit a data packet in time within the TWT SP such that a problem that the data packet is lost due to a timeout can be avoided, and quality of service of a low-delay service can be improved.

The above general descriptions and the following detailed descriptions are merely exemplary and explanatory, and are not intended to limit this application.

### BRIEF DESCRIPTION OF THE DRAWINGS

FIG. 1 is a schematic diagram of an implementation environment involved in this application;

FIG. 2 is a flowchart of a data transmission control method according to an exemplary embodiment of this application;

FIG. 3 is a flowchart of a data transmission control method according to another exemplary embodiment of this application;

FIG. 4 is a schematic diagram of a format of a target wake time (TWT) element;

FIG. 5 is a flowchart of a data transmission control method according to yet another exemplary embodiment of this application;

FIG. 6 shows a schematic diagram of a comparison with a broadcast information subfield specified by a sixth-generation wireless fidelity (Wi-Fi) network (Wi-Fi 6) standard;

FIG. 7 is a flowchart of a data transmission control method according to yet another exemplary embodiment of this application;

FIG. 8 is a flowchart of a data transmission control method according to yet another exemplary embodiment of this application;

FIG. 9 shows another schematic diagram of a comparison with a broadcast information subfield specified by a Wi-Fi 6 standard;

FIG. 10 is a flowchart of a data transmission control method according to still another exemplary embodiment of this application;

FIG. 11 is a schematic diagram of a format of an exemplary broadcast information field;

FIG. 12 is a schematic diagram of a format of an exemplary delay information control field;

FIG. 13 is a schematic diagram of a format of another exemplary delay information control field;

FIG. 14 is a block diagram of a data transmission control apparatus according to an exemplary embodiment of this application; and

FIG. 15 is a schematic structural diagram of a computer system suitable for implementing an electronic device according to an embodiment of this application.

### DESCRIPTION OF EMBODIMENTS

Exemplary embodiments are described in detail herein, and examples of the exemplary embodiments are shown in the accompanying drawings. When the following descriptions involve accompanying drawings, unless otherwise indicated, the same numerals in different accompanying drawings represent the same or similar elements. The implementations described in the following exemplary embodiments do not represent all implementations consistent with this application. On the contrary, these implementations are merely examples of an apparatus and a method consistent with some aspects of this application as detailed in the appended claims.

The block diagrams shown in the accompanying drawings are merely functional entities and do not certainly correspond to physically independent entities. That is, these functional entities may be implemented in a software form, or in one or more hardware modules or integrated circuits, or in different networks and/or processor apparatuses and/or microcontroller apparatuses.

The flowcharts shown in the accompanying drawings are merely exemplary descriptions, do not need to include all content and operations/steps, and are not required to be performed in the described orders either. For example, some operations/steps may be decomposed, while some operations/steps may be combined or partially combined. Thus, an actual execution sequence may change according to an actual situation.

The term “plurality of” mentioned in this application means two or more. The term “and/or” describing an association relationship between associated objects denotes that there can be three relationships. For example, A and/or B can denote: A alone, both A and B, and B alone. The character “/” generally denotes an “or” relationship between the associated objects.

The terms such as “first”, “second”, “third”, and “fourth” in the description and claims of this application and in the accompanying drawings are configured for distinguishing different objects and not certainly configured for describing a specific sequence. The terms “include”, “have”, and their variants are intended to cover a non-exclusive inclusion. For example, a process, method, system, product, or device that includes a series of steps or units is not limited to the listed steps or units, and further includes, in some embodiments, a step or unit that is not listed, or further includes, in some embodiments, another step or unit that is intrinsic to the process, method, product, or device.

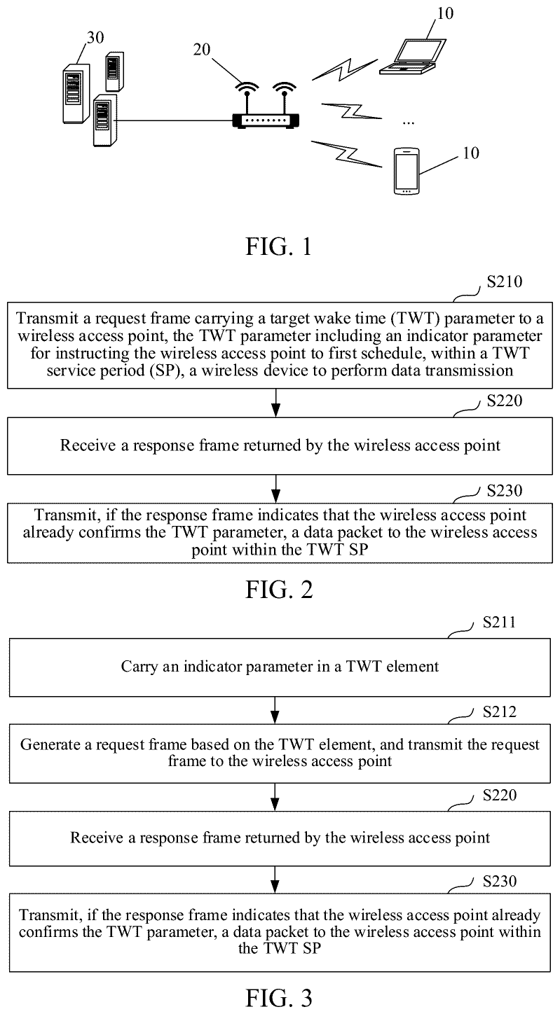

With reference to FIG. 1, a schematic diagram of an implementation environment involved in this application is show in FIG. 1. The exemplary implementation environment illustrates a scenario of a low-delay service.

Specifically, the wireless device 10 is connected to the wireless access point 20. The wireless access point 20 pre-establishes a wired or wireless network connection to a service server 30. Thus, data is transmitted between the wireless device 10 and the service server 30 by the wireless access point 20.

In the scenario of the low-delay service, the wireless device 10 also performs data transmission related to the low-delay service with the wireless access point 20, including transmission of uplink data and transmission of downlink data. The uplink data is, for example, application data generated by a low-delay application mounted in the wireless device 10. The downlink data is, for example, service data transmitted by the service server 30 to the wireless device 10.

The wireless device 10 may be a terminal device such as a smart phone, a tablet computer, a notebook computer, a computer, a smart watch, a smart television, a smart camera, and an aircraft. The wireless access point 20 may be a device having a wireless access function, such as a wireless router. The service server 30 may be an independent physical server, a server cluster or a distributed system composed of a plurality of physical servers, or a cloud server providing a basic cloud computation service such as a cloud service, a cloud database, cloud computation, a cloud function, cloud storage, a network service, cloud communication, a middleware service, a domain name service, a security service, a content delivery network (CDN), big data, and an artificial intelligence platform. Specific device types of the wireless device 10, the wireless access point 20, and the service server 30 are not limited in the embodiment.

The low-delay service shown in FIG. 1 may be a financial and electronic transaction service, a high-definition video service (for example, service scenarios such as a game application, a high-definition live video streaming and on-demand application, and a virtual reality application), etc. These service scenarios have relatively high requirements on a low delay. Specific service scenarios are not limited in this application.

In an actual application a scenario of a low-delay service, due to limitation of a maximum delay, a data packet exceeding the maximum delay will be deleted and lost, resulting in decrease in quality of service.

For example, in a cloud game scenario, the wireless device 10 is specifically a cloud game terminal. A cloud game client program runs on the wireless device. The service server 30 is specifically a cloud game server. A cloud game server program runs on the service server. In a game process, a cloud game terminal is required to transmit operation data in a game picture to a cloud game server. Thus, the cloud game server performs rendering to generate a next frame of game picture according to the received operation data and delivers the next frame of game picture to the cloud game terminal. The operation data in the game picture is required to be uploaded to the cloud game server in time. A game picture generated in the cloud game server is required to be delivered to the cloud game terminal in time. In this way, a game user can be ensured to have smooth game experience. Thus, requirements for a low-latency performance of data transmission are high.

In a case of the uplink data, a data packet generated by a low-delay application enters a queue for waiting on a wireless-device 10 side. Information such as arrival time and waiting time of the data packet is mastered only on the wireless-device 10 side. The wireless access point 20 cannot determine in advance a proportion of data lost due to a timeout. Thus, the problem of packet loss of data of a low-delay service caused by a timeout is difficult to resolve by the wireless access point 20.

Moreover, in a target wake time (TWT) mechanism, data is required to be transmitted between the wireless device 10 and the wireless access point 20 within a TWT service period (SP) agreed on by the two parties. Generally, a plurality of wireless devices 10 are connected to the wireless access point 20. As wireless devices 10 connected to the wireless access point 20 are added, a probability that the wireless access point 20 schedules a particular wireless device 10 decreases. The wireless device 10 is required to wait for a next TWT SP if a TWT SP is missed. Thus, a relatively large delay is generated, and a problem of packet loss of service data due to a timeout is caused.

To resolve the above problem, embodiments of this application provide a data transmission control method, a data transmission control apparatus, an electronic device, a computer-readable storage medium, and a computer program product respectively. These embodiments will be described in detail in subsequent content.

In addition, since these embodiments of this application are provided based on a TWT mechanism, to improve understanding of these embodiments, a TWT technology is required to be briefly introduced before the embodiments of this application are described.

First, the TWT technology is configured for resolving a problem of a collision of competitive channels between wireless devices (also referred to as stations (STAs)) in a big connection scenario and a problem of power consumption of a power-consumption-sensitive wireless device. The TWT technology schedules a wireless device to wake at different time such that collisions, back-off, waiting, and retransmission caused by a large number of competitive channels can be effectively reduced. Moreover, in a sleep stage, a wireless device will turn off a wireless radio frequency such that power consumption of the device can be effectively reduced.

A broadcast TWT operating mode of the TWT technology is referred to as a B-TWT for short. In the B-TWT mode, a wireless access point (also referred to as an access point (AP)) uniformly allocates TWT SPs, and periodically broadcasts a TWT parameter by using a beacon frame (also referred to as a beacon). A wireless device is required to be authorized to join a TWT group or request to create a new TWT group, to transmit data within a corresponding TWT SP.

The above process is also referred to as B-TWT negotiation. Different from a conventional handshake negotiation mechanism, the B-TWT negotiation uses only one TWT setup frame. A requester and a responder put TWT parameters into the TWT setup frame by using target wake time (TWT) information elements respectively. The negotiation is completed based on changes of the TWT parameters.

Joining a TWT group and data transmission in a B-TWT mode include processes as follows:

A wireless device initiates a TWT request frame. The TWT request frame includes a TWT element carrying a TWT SP parameter expected to be added. A wireless access point returns a TWT response frame. The response frame includes a TWT element carrying a TWT parameter determined by the wireless access point. It is determined that a TWT group is established. Then, the wireless device enters a sleep state until an agreed-on beacon period to which a TWT SP belongs starts, wakes and receives a beacon frame broadcast by the wireless access point, reads a TWT element field carried in a beacon frame, and obtains latest TWT SP information. The wireless device sleeps again until the TWT SP starts, and transmits a data packet to the wireless access point.

When a parameter in the TWT element specifies that a trigger frame is transmitted, the wireless device waits to receive the trigger frame broadcast by the wireless access point, and returns a corresponding frame after receiving the trigger frame, to notify the wireless access point that the wireless device is already woken and can receive downlink data. After the wireless access point finishes transmitting data, the wireless device restores to the sleep state until a next TWT SP starts.

According to the above introduction of the TWT technology, in a current B-TWT negotiation mechanism, the wireless access point cannot master a data caching status on a wireless device side, and thus cannot actively first schedule the wireless device. Moreover, as a number of members in the TWT group increases, a probability that the wireless access point schedules a particular wireless device decreases. That is, as the number of members in the TWT group increases, a probability that the wireless access point cannot schedule a particular wireless device to transmit uplink data within a latest TWT SP increases. Thus, the current B-TWT negotiation mechanism is likely to cause a problem of packet loss of data of a low-delay service in a wireless device caused by a timeout.

To resolve the problem, the inventor of this application uniquely conceives that a wireless device supporting a low-delay service may instructs, by improving a signaling, a wireless access point to first schedule uplink data of a low-delay service of the wireless device, to ensure a data packet in the wireless device supporting the low-delay service to be transmitted in time, and to avoid a problem of packet loss caused by a timeout. Thus, quality of service of the low-delay service can be improved.

In addition, in a non-low-delay service scenario, the technical solution provided in the embodiment may still be used. That is, the wireless device may still instruct, by using a signaling, the wireless access point to first schedule the wireless device. Application scenarios related to related embodiments are not limited in this application.

FIG. 2 is a flowchart of a data transmission control method according to an exemplary embodiment of this application. The method is applied to a wireless device (that is, an STA) connected to a wireless access point (that is, an AP). For example, the method may be specifically performed by the wireless device 10 in the implementation environment shown in FIG. 1, which is not limited herein.

As shown in FIG. 2, the data transmission control method includes S210-S230, which will be introduced in detail as follows:
S210: Transmit a request frame carrying a TWT parameter to the wireless access point. The TWT parameter includes an indicator parameter for instructing the wireless access point to first schedule, within a TWT SP, the wireless device to perform data transmission.

Generally, a wireless device performs queue cashing on a data packet generated by a low-delay application and then transmits the data packet. According to a feature of a low-delay service, the data packet has timeliness. If a data packet cached in the queue does not obtain a transmitting opportunity for a long time, the packet will be lost.

As an exemplary implementation, before S210, the method may further include:
determine, according to a service data feature of the wireless device, whether the data packet is to be lost due to a timeout, the service data feature being information for describing a feature of data related to a service in the wireless device; and
transmit, if a determination result indicates that the data packet is to be lost due to a timeout, the request frame carrying the TWT parameter to the wireless access point.

For example, the wireless device may determine, according to the service data feature of the wireless device, whether a data packet is lost due to a timeout, and then transmit a corresponding request frame to the wireless access point according to a determination result. Specifically, if the determination result indicates that the data packet will be lost due to a timeout, the TWT parameter carried in the request frame transmitted by the wireless device includes the indicator parameter. The indicator parameter is configured for instructing the wireless access point to first schedule, within the TWT SP, the wireless device to perform data transmission. Thus, a data packet cached by the wireless device can be transmitted in time through first scheduling of the wireless access point. If a determination result indicates that no timeout will occur on the data packet, the request frame transmitted by the wireless device may not carry the indicator parameter, or may still carry a field of the indicator parameter, but a value of the field is required to be set as a negative value.

The service data feature of the wireless device refers to information for describing a feature of data related to a service in the wireless device. For example, the service data feature includes a number of data packets cached in a queue, arrival time of the data packet, a life cycle of the data packet, etc., which will not be enumerated herein. These service data features may be obtained by using a current caching status of the wireless device, or may be obtained by expecting service data in the wireless device. Since service data in the wireless device is generally periodic, a service data feature may be expected according to a historical transmission status of the service data.

As another exemplary implementation, the method may further include:
the wireless device may determine, according to a service data feature of the wireless device, a level at which first scheduling is required to be performed, and carry the level to the request frame as an indicator parameter for instructing the wireless access point to first schedule the wireless device.

Or in another exemplary implementation, the indicator parameter carried in the request frame and configured for instructing the wireless access point to first schedule the wireless device within the TWT SP may also be set as one or more of the foregoing service data features. After these indicator parameters are transmitted to the wireless access point, the wireless access point determines, based on these indicator parameters, whether to first schedule the wireless device.

Regardless of which implementation, the wireless device instructs, according to the service data feature of the wireless device, the wireless access point to first schedule the wireless device. Thus, a problem that a data packet in the wireless device is lost due to a timeout can be avoided. In addition, since a request for first scheduling is initiated by the wireless device, the wireless access point can clearly know a wireless device that is required to be first scheduled. Thus, a problem that the wireless access point cannot implement precise scheduling due to uncertainty of TWT SP scheduling can be avoided.

Other TWT parameters except for the indicator parameter carried in the request frame can be obtained with reference to related provisions in the TWT technical standard. For example, other TWT parameters include a TWT SP which the wireless device wants to join, which will not be enumerated herein. The TWT SP which the wireless device wants to join is uniformly allocated by the wireless access point to be broadcast to the wireless device by using a beacon frame.

S220: Receive a response frame returned by the wireless access point.

After receiving the request frame transmitted by the wireless device, the wireless access point returns a corresponding response frame to the wireless device. The response frame carries a TWT parameter confirmed by the wireless access point, to confirm to the wireless device that a TWT group relationship is established.

If the response frame represents that the wireless access point agrees on and confirms content requested by the wireless device by using the request frame, that is, the wireless device knows by using the response frame that the wireless access point already confirms the TWT parameter carried in the request frame, the wireless device enters a sleep state after receiving the response frame, to reduce power consumption of the device. Moreover, the TWT technology stipulates that the wireless device is woken at the beginning of a beacon period to which an agreed-on TWT SP belongs, receives a beacon frame transmitted by the wireless access point, reads a TWT element field carried in the beacon frame, and obtains latest TWT SP information. Then, the wireless device sleeps again until a TWT SP starts, and transmits a data packet to the wireless access point.

If the response frame represents that the wireless access point does not agree on the content requested by the wireless device, the wireless device may retransmit the request frame to the wireless access point, to re-request the wireless access point to first schedule data transmission of the wireless device within the TWT SP.

In an actual application scenario, specific content of the response frame returned by the wireless access point for the request frame transmitted by the wireless device may be implemented according to a wireless protocol standard specifically implemented, which will not be repeated herein.

S230: Transmit, if the response frame indicates that the wireless access point already confirms the TWT parameter, a data packet to the wireless access point within the TWT SP.

As mentioned above, if the response frame indicates that the wireless access point already confirms the TWT parameter carried in the request frame by the wireless device, the wireless access point already confirms that the wireless device is first scheduled within the TWT SP. Thus, when the TWT SP arrives, the wireless device transmits a data packet cached by the wireless device to the wireless access point. Since the wireless access point performs first scheduling within the TWT SP according to an indicator of the wireless device, a timeout can be avoided when the wireless device transmits a data packet within the TWT SP. Thus, a problem of reduced quality of service caused by packet loss caused by a timeout will not occur.

In technical solutions provided in embodiments of this application, a wireless device instructs, by using a signaling, a wireless access point to first schedule uplink data of the wireless device. That is, when a response frame received by the wireless device indicates that the wireless access point already confirms a TWT parameter carried in a request frame transmitted by the wireless device, the wireless access point acquires and confirms a TWT SP expected by the wireless device, and correspondingly acquires and confirms an expectation that the wireless device is first scheduled within the TWT SP. Thus, the wireless device can transmit a data packet in time within the TWT SP such that a problem that the data packet is lost due to a timeout can be avoided, and quality of service of a low-delay service can be improved.

FIG. 3 is a flowchart of a data transmission control method according to another exemplary embodiment of this application. The embodiment illustrates that S210 in the embodiment shown in FIG. 2 further includes operations as follows:
S211: Carry the indicator parameter in a TWT element; and
S212: Generate the request frame based on the TWT element, and transmit the request frame to the wireless access point.

As mentioned above, in a B-TWT mode, a requester and a responder put TWT parameters into a TWT setup frame by using TWT elements respectively, and negotiation is completed based on changes of the TWT parameters. Thus, the indicator parameter involved in the embodiment is carried in the TWT element. In the embodiment, the request frame generated based on the TWT element is a TWT setup frame.

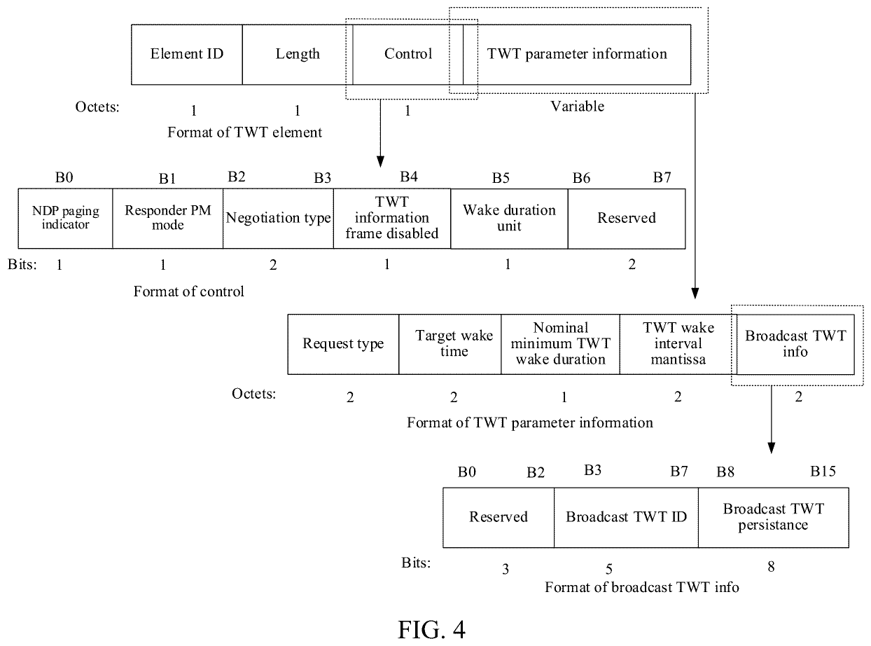

FIG. 4 is a schematic diagram of a format of a TWT element. As shown in FIG. 4, the TWT element is defined as a general format including an element identity (ID) field of 1 octet (representing that an Internet standard uses an octet), a length field of 1 octet, a control field of 1 octet, and a length-variable TWT parameter information field.

Still with reference to FIG. 4, the control field is composed of a null data packet (NDP) paging indicator subfield of 1 bit (in a binary digit), a responder power management (PM) mode subfield of 1 bit, a negotiation type subfield of 2 bits, a TWT information frame disabled subfield of 1 bit, a wake duration unit subfield of 1 bit, and a reserved subfield of 2 bits. The negotiation type subfield indicates which operating mode the information in the TWT elements correspond to. If a broadcast field of the negotiation type subfield is set as 1, a B-TWT operating mode is indicated. A TWT parameter information field of the TWT element includes a broadcast TWT parameter set. The TWT information frame disabled subfield indicates whether the wireless device disables reception of a TWT information frame. The wake duration unit subfield indicates a unit of a nominal minimum TWT wake duration subfield in the TWT parameter information field.

A format of the TWT parameter information field is still shown in FIG. 4. The TWT parameter information field is composed of a request type subfield of 2 octets, a target wake time subfield of 2 octets, a nominal minimum TWT wake duration subfield of 1 octet, a TWT wake interval mantissa subfield of 2 octets, and a broadcast TWT info subfield of 2 octets. A format of the broadcast TWT info subfield is still shown in FIG. 4. The broadcast TWT info subfield is composed of a reserved field of 3 bits, a broadcast TWT ID field of 5 bits, and a broadcast TWT persistance field of 8 bits. The format of the TWT element shown above is specified by a sixth-generation Wi-Fi wireless network (Wi-Fi 6) standard. Detailed functions and use methods of the fields will not be described in detail herein.

In an embodiment of this application, the TWT parameter information field is referred to as a parameter information field. The broadcast TWT info subfield is referred to as a broadcast information subfield. These fields are important fields for carrying TWT parameters.

In an exemplary embodiment, S211 specifically includes S2111-S2112 as follows:
S2111: Search for a broadcast information subfield from a parameter information field included in the TWT element, and include a first indicator field in the broadcast information subfield; and
S2112: Configure a value of the first indicator field according to a service data feature of the wireless device, and take the value of the first indicator field as the indicator parameter.

In the embodiment, the first indicator field is included in the broadcast information subfield. A value of the first indicator field is set, such that the indicator parameter is carried in the TWT element. Further, the indicator parameter is carried in the request frame. Since only 3 bits remain in the broadcast TWT info subfield stipulated by the Wi-Fi 6 standard, a length of the first indicator field can be set as 1 bit, or may be set to be greater than 1 bit, but cannot be set to exceed 3 bits.

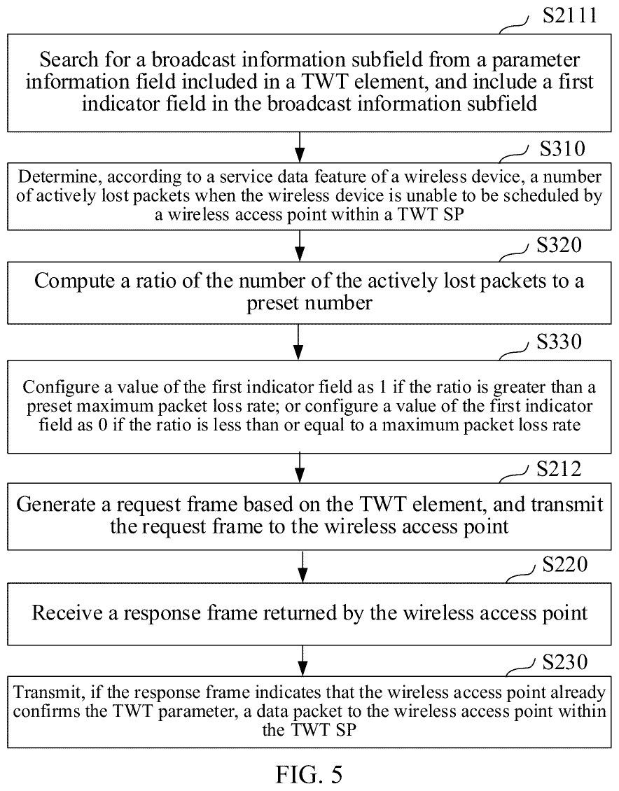

As an exemplary implementation, as shown in FIG. 5, S2112 is specifically implemented by S310 to S330:
S310: Determine, according to the service data feature of the wireless device, a number of actively lost packets when the wireless device is unable to be scheduled by the wireless access point within the TWT SP;
S320: Compute a ratio of the number of the actively lost packets to a preset number;
S330: Configure the value of the first indicator field as a first value if the ratio is greater than a preset maximum packet loss rate; or configure the value of the first indicator field as a second value if the ratio is less than or equal to the maximum packet loss rate.

The preset number mentioned in the exemplary embodiment represents a total number of data packets generated by the low-delay service in one period. The preset maximum packet loss rate represents a maximum packet loss rate required by the low-delay service.

Since the data of the low-delay service has periodicity, that is, a total number of upper-layer data packets arriving within the period is stable, but arrival time of the data packets is random within the period, a total number of data packets generated within one period by the low-delay service can be known.

A case that a wireless device is unable to be scheduled by a wireless access point within a TWT SP means that a data packet in the wireless device cannot perform data interaction with the wireless access point according to a conventional TWT mechanism, and the data packet in the wireless device cannot be transmitted to the wireless access point. Thus, the number is referred to as a number of actively lost packets of the wireless device. Under this condition, the wireless device can determine, according to an obtained number of actively lost packets, whether the wireless access point is required to first schedule data transmission of the wireless device.

Specifically, a ratio of the number of the actively lost packets of the wireless device to the preset number represents the packet loss rate. If a ratio of a number of actively lost packets when the wireless device is unable to be scheduled by the wireless access point to a total number of data packets generated in one period by the low-delay service is greater than a maximum packet loss rate required by the low-delay service, a packet loss rate of uplink data of the wireless device cannot satisfy a requirement of the low-delay service, and the wireless access point is required to be instructed to first schedule the uplink data. Thus, the first indicator field is included in the broadcast TWT info subfield, and a value of the first indicator field is set as a first value, for example, 1.

If a ratio of the number of actively lost packets when the wireless device is unable to be scheduled by the wireless access point to a total number of data packets generated by the low-delay service in one period is less than or equal to a maximum packet loss rate required by the low-delay service, a packet loss rate of uplink data of the wireless device can satisfy a requirement of the low-delay service. In this case, the first indicator field may not be added to the broadcast TWT info subfield, or a value of the first indicator field may be set as a second value, for example, 0.

That is, in the implementation, the first indicator field having a field value of 1 is included in the broadcast TWT info subfield such that the wireless access point can be instructed to first schedule uplink data of the wireless device within the TWT SP. Thus, a problem that a data packet cached in the wireless device is lost due to a timeout can be avoided. Further, the wireless device can satisfy a requirement of a low-delay service.

In addition, with an example in which the first value represents 1, since a length of the first indicator field does not exceed 3 bits at most, when the length of the first indicator field is set as 1 bit, the value of the first indicator field is specifically set as “1”. When the length of the first indicator field is set as 2 bits, the value of the first indicator field is specifically set as “01”. When the length of the first indicator field is set as 3 bits, the value of the first indicator field is specifically set as “001”. A method of setting the value of the first indicator field as 0 is similar to this method, and will not be repeated herein.

In addition, when the length of the first indicator field is set as 2 bits or 3 bits, the first value may be set as another value except for 1, for example, 2. In this case, the value of the first indicator field is specifically set as “10”, or 7. In this case, the value of the first indicator field is specifically set as “111”. In the embodiment, the specific value represented by the first value is not limited, but the first value is required to be distinguished from the second value.

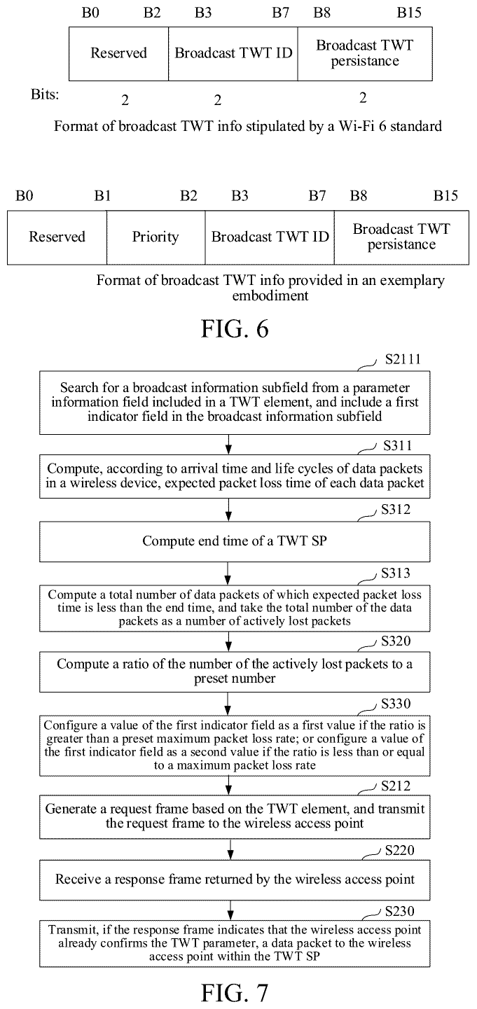

As shown in FIG. 6, a format of the broadcast TWT info subfield stipulated by the Wi-Fi 6 standard is a first format shown in FIG. 6. A format of the broadcast TWT info subfield including the first indicator field according to the implementation is a second format shown in FIG. 6. By comparing the two formats, in the exemplary implementation, first indicator field priority is included in the broadcast TWT info subfield, such that indicator information for instructing the wireless access point to first schedule the wireless device within the TWT SP is carried in the broadcast TWT info subfield.

FIG. 7 shows a process of determining, according to a service data feature of a wireless device, a number of actively lost packets when the wireless device is unable to be scheduled by a wireless access point within a TWT SP in S310. The process includes S311 to S313 shown as follows:
S311: Compute, according to arrival time and life cycles of data packets in the wireless device, expected packet loss time of each data packet;
S312: Compute end time of the TWT SP; and
S313: Compute a total number of data packets of which the expected packet loss time is less than the end time, and take the total number of the data packets as the number of the actively lost packets.

In another exemplary embodiment, a process of computing, according to arrival time and life cycles of data packets in the wireless device, expected packet loss time of each data packet in S311 includes: compute a sum of the arrival time of each data packet and the life cycle of each data packet in the wireless device, and obtain the expected packet loss time of each data packet.

Arrival time of a data packet in a wireless device refers to time at which the data packet is transmitted from an application layer to a media access control (MAC) layer. A life cycle of a data packet may be understood as duration of the data packet. In the embodiment, a sum of arrival time of each data packet cached in the wireless device and a life cycle of each data packet is computed, and expected packet loss time of each data packet can be correspondingly obtained.

For ease of understanding, after the data packet is generated at the application layer and arrives at the MAC layer, if the duration for which the data packet stays in the wireless device exceeds a life cycle, the data packet is deleted, resulting in packet loss. Thus, a sum of arrival time and a life cycle of a data packet may be represented as expected packet loss time of the data packet.

In a case of an ith data packet cached in the wireless device, if arrival time of the data packet is represented as t₀ⁱ, a life cycle of the data packet is represented as Tⁱ, expected packet loss time of the data packet is represented as t₁ⁱ, and expected packet loss time of the data packet may be computed by using a formula as follows: t₁ⁱ.

$${t}_{1}^{i} = {t}_{0}^{i} + {T}^{i}$$

As mentioned above, in the B-TWT mode, the TWP SP is obtained through negotiation between the wireless device and the wireless access point. The wireless device transmits an expected TWT parameter to the wireless access point by using a TWT setup frame. The expected TWT parameter includes information of the TWP SP. Thus, the wireless device can compute the end time of the TWT SP based on the information.

For example, the end time of the TWT SP may be computed by using a formula as follows: t_{end}.

$${t}_{end} = [ target wake time ] + [ interval Mantissa ] \times {2}^{[ interval exponent ]}$$

Specifically, target wake time is a value of a target wake time subfield shown in FIG. 4 and indicates target wake time, interval Mantissa is a value of a TWT wake interval mantissa subfield shown in FIG. 4 and indicates a TWT wake interval mantissa, and interval exponent is a parameter included in the request type subfield shown in FIG. 4 and indicates a TWT wake interval index.

If expected packet loss time of a data packet is less than the end time of the TWT SP, the expected packet loss time will arrive before the end time of the TWT SP. As a result, the data packet may be lost due to a timeout. Thus, a total number of data packets of which expected packet loss time is less than the end time is counted such that a number of actively lost packets of the wireless device can be obtained. Further, a value of the first indicator field can be configured according to the number of actively lost packets such that indicator information can be carried in a TWT element. A process of configuring a value of the first indicator field can be obtained with reference to the recitation in the foregoing embodiments, and will not be repeated herein.

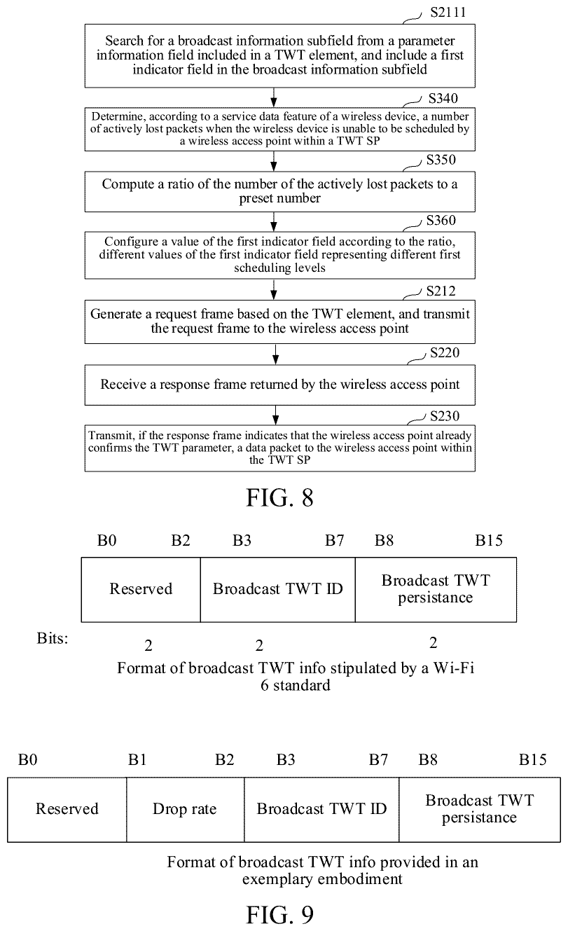

As another exemplary implementation, as shown in FIG. 8, S2112 is implemented through S340 to S360:
S340: Determine, according to the service data feature of the wireless device, a number of actively lost packets when the wireless device is unable to be scheduled by the wireless access point within the TWT SP;
S350: Compute a ratio of the number of the actively lost packets to a preset number; and
S360: Configure the value of the first indicator field according to the ratio, where different values of the first indicator field represent different first scheduling levels.

In the exemplary implementation, a computation process involved in S340 and S350 is the same as that in S310 and S320, and will not be repeated herein. In S360, the first indicator field is configured in the broadcast TWT info subfield according to the ratio obtained in S350, and different values of the first indicator field indicate different first scheduling levels. Thus, more first scheduling methods can be provided for the wireless access point.

In a big connection scenario, numerous wireless devices are connected to the wireless access point generally. These wireless devices may compete with each other for a first scheduling opportunity from the wireless access point according to a value of the first indicator field carried in the request frame. The higher the first scheduling level, the higher a priority of consideration of data transmission performed by the wireless access point within the TWT SP. If the first scheduling levels are the same, the wireless access point may schedule different wireless devices within the TWT SP according to a principle of first come, first allocated.

For example, a value of the first indicator field may represent one of a first first scheduling level, a second first scheduling level, a third first scheduling level, and a fourth first scheduling level. A first wireless device, a second wireless device, a third wireless device, and a fourth wireless device are all connected to the wireless access point. If a value of a first indicator field in a request frame transmitted by the first wireless device to the wireless access point represents a first first scheduling level, values of first indication fields in request frames transmitted by the second wireless device and the third wireless device represent a second first scheduling level, and a value of a first indicator field in a request frame transmitted by the fourth wireless device represents a fourth first scheduling level, the wireless access point first schedules a TWT SP for the fourth wireless device, then schedules TWT SPs for the second wireless device and the third wireless device according to a sequence of receiving the request frames, and finally schedules a TWT SP for the first wireless device.

In an exemplary embodiment, S360 includes processes as follows:
configure the value of the first indicator field as a third value if the ratio is less than a preset first packet loss rate;
configure the value of the first indicator field as a fourth value if the ratio is greater than the first packet loss rate and less than a preset second packet loss rate;
configure the value of the first indicator field as a fifth value if the ratio is greater than the second packet loss rate and less than a preset third packet loss rate; or
configure the value of the first indicator field as a sixth value if the ratio is greater than the third packet loss rate.

The third value, the fourth value, the fifth value, and the sixth value mentioned above represent different first scheduling levels. In an exemplary implementation, the lower a value of the first indicator field is, a higher a represented first scheduling level is. For example, a first value may be set as 0, a second value may be set as 1, a third value may be set as 2, and a fourth value may be set as 3. In another exemplary implementation, the higher a value of the first indicator field is, a higher a represented first scheduling level is. For example, a first value may be set as 3, a second value may be set as 2, a third value may be set as 1, and a fourth value may be set as 0. In an actual application scenario, representation methods of different values of the first indicator field for different first scheduling levels may be set according to an actual requirement, which is not limited herein.

In the above process, a value of the first indicator field is configured according to a comparison result between ratios obtained in S350 and different preset packet loss rates. Thus, a packet loss status of the wireless device can be mapped based on different values of the first indicator field, and different first scheduling levels can be determined. For example, a preset first packet loss rate, a preset second packet loss rate, and a preset third packet loss rate are 1/10000, 1/1000, and 1/100 respectively. When a ratio obtained through S350 is less than 1/10000, a packet loss rate of data in the wireless device is extremely small. Similarly, when a ratio obtained through S350 is greater than 1/100, a packet loss rate of data in the wireless device is extremely great. Thus, first scheduling levels corresponding to the first indicator field from the third value to the sixth value are sequentially increased.

In some other exemplary embodiments, in S360, the ratio obtained in S350 may be further computed, and the value of the first indicator field is configured according to a computation result. For example, a logarithmic operation or another operation may be performed on the ratio.

Exemplarily, if a logarithmic operation is performed on the ratio obtained in S350, S360 includes processes as follows:
set a value of a second indicator field as a third value if an obtained operation result is less than −3;
set a value of a second indicator field as a fourth value if an obtained operation result is greater than −3 and less than −2;
set a value of a second indicator field as a fifth value if an obtained operation result is greater than −2 and less than −1; or
set a value of a second indicator field as a sixth value if an obtained operation result is greater than −1.

Similarly, in some exemplary implementations, the lower a value of the first indicator field is, a higher a represented first scheduling level is. For example, a first value may be set as 0, a second value may be set as 1, a third value may be set as 2, and a fourth value may be set as 3. In another exemplary implementation, the higher a value of the first indicator field is, a higher a represented first scheduling level is. For example, a first value may be set as 3, a second value may be set as 2, a third value may be set as 1, and a fourth value may be set as 0. In an actual application scenario, representation methods of different values of the first indicator field for different first scheduling levels may be set according to an actual requirement, which is not limited herein.

The wireless access point may determine the first scheduling level of the wireless device according to the expected packet loss rate of the wireless device. For ease of understanding, for example, if a manner in which the lower a value of the first indicator field, the higher a represented first scheduling level is selected, the first value is set as 0, the second value is set as 1, the third value is set as 2, and the fourth value is set as 3. The expected packet loss rate of the wireless device may be preset to be represented as 1/10 when the first indicator field is 3. The expected packet loss rate of the wireless device is represented as 1/100 when the first indicator field is 2. The expected packet loss rate of the wireless device is represented as 1/1000 when the first indicator field is 1. The expected packet loss rate of the wireless device is represented as 1/10000 when the first indicator field is 0. Thus, the lower a value of the first indicator field, the greater an expected packet loss rate of a corresponding wireless device, and the higher a represented first scheduling level.

In the implementation, the first indicator field able to indicate different first scheduling levels is set in the broadcast TWT info subfield such that the wireless access point can precisely schedule a TWT SP of the wireless device based on the first scheduling levels. For example, in an application scenario that a plurality of wireless devices join a same TWT group, the wireless access point may receive request frames transmitted by the plurality of wireless devices and carrying first indicator fields. In this case, the wireless access point may allocate TWT SPs to the plurality of wireless devices according to first scheduling levels indicated by the first indicator fields corresponding to the wireless devices. In this way, stability of a low-delay service in a multi-wireless-device connection scenario can be ensured to the utmost extent.

In addition, as shown in FIG. 9, a format of the broadcast TWT info subfield stipulated by the Wi-Fi 6 standard is a first format shown in FIG. 9. A format of the broadcast TWT info subfield after the first indicator field is added according to the implementation is a second format shown in FIG. 9. By comparing the two formats, in the exemplary implementation, first indicator field drop rate is added such that indicator information for instructing the wireless access point to first schedule the wireless device within the TWT SP is carried in the broadcast TWT info subfield.

Since only 3 bits remain in the broadcast TWT info subfield stipulated by the Wi-Fi 6 standard, a length of the first indicator field in the embodiment can be set as at least 2 bits, but cannot be set to exceed 3 bits.

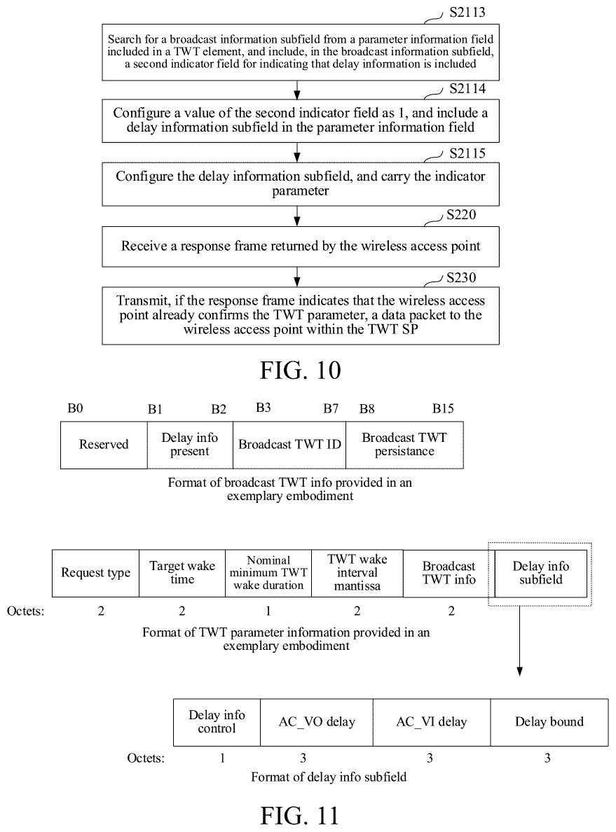

As another exemplary embodiment, as shown in FIG. 10, S211 specifically includes S2113 to S2115 as follows:
S2113: Search for a broadcast information subfield from a parameter information field included in the TWT element, and include, in the broadcast information subfield, a second indicator field for indicating that delay information is included;
S2114: Configure a value of the second indicator field as 1, and include a delay information subfield in the parameter information field; and
S2115: Configure the delay information subfield, and carry the indicator parameter.

In the embodiment, the second indicator field is included in the broadcast TWT info subfield. When a value of the second indicator field is configured as 1, the second indicator field is configured for indicating that delay information exists. Thus, the wireless access point can notice the existing delay information when processing the request frame, and perform corresponding processing on the delay information.

In another exemplary embodiment, the delay information subfield carries a delay processing parameter. Reference information for determining whether to first schedule the wireless device within the TWT SP is transmitted to the wireless access point by using the delay processing parameter. Thus, whether to first schedule the wireless device is determined by the wireless access point based on the reference information carried in the request frame.

Specifically, delay information subfield is further included at an end of a TWT parameter information field. The delay information subfield is configured for carrying the delay processing parameter. When processing the request frame, after obtaining by parsing the broadcast TWT info subfield that the delay information exits, the wireless access point further parses the delay information subfield located at the end of the TWT parameter information field, and obtains a specific delay processing parameter.

In a case of the wireless device, on the one hand, the second indicator field is added to the broadcast TWT info subfield such that the wireless access point is required to be instructed to further parse the request frame. On the other hand, the delay information subfield located at the end of the TWT parameter information field carries a specific delay processing parameter such that reference information for determining whether to first schedule the wireless device within the TWT SP is transmitted to the wireless access point. Further, whether to first schedule the wireless device is determined by the wireless access point based on information carried in the request frame.

As shown in FIG. 11, exemplarily, in the implementation, a second indicator field delay info present is added to a broadcast TWT info subfield. A delay information subfield delay info subfield is added at the end of the TWT parameter information field. The delay information subfield delay info subfield is configured for carrying indicator information.

Exemplarily, the delay processing parameter mentioned above includes an accumulated delay in a specified queue for caching data in the wireless device. The specified queue may be understood as at least one queue in the wireless device, and for example, includes two queues having highest priorities. Uplink data of the wireless device is cached in a queue for caching data and then is transmitted. Moreover, a plurality of queues generally exist in a wireless device. Different queues generally have different priorities.

As exemplified in FIG. 11, the delay information subfield is composed of a delay info control field of 1 octet, an AC_VO delay field of 3 octets, an AC_VI delay field of 3 octets, and a delay bound field of 3 octets, where AC_VO and AC_VI represent two queues having highest priorities in the wireless device.

In the embodiment, the delay info control field is referred to as a delay information control field and configured for defining a delay information subfield. The AC_VO delay field and the AC_VI delay field are referred to as queue delay fields corresponding to a queue AC_VO and a queue AC_VI respectively.

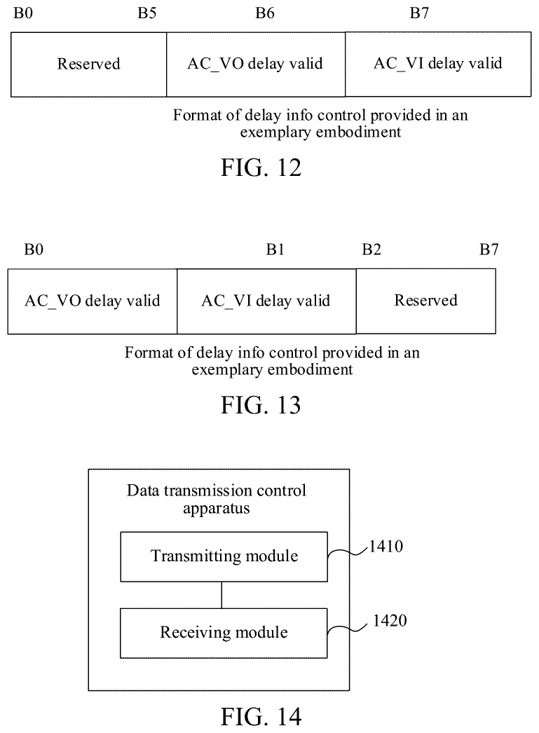

FIG. 12 shows a format of the delay info control field. The delay info control field includes a reserved subfield of 6 bits, an AC_VO delay valid subfield of 1 bit, and an AC_VI delay valid subfield of 1 bit. The AC_VO delay valid subfield and the AC_VI delay valid subfield are referred to as delay validity subfields, and are configured for defining validity of the AC_VI delay field and the AC_VI delay field.

FIG. 12 shows that the AC_VO delay valid subfield and the AC_VI delay valid subfield are set at high bits of the delay info control field. Certainly, as another exemplary implementation, as shown in FIG. 13, the AC_VO delay valid subfield and the AC_VI delay valid subfield may alternatively be set at low bits of the delay info control field, which is not limited herein.

In an exemplary embodiment, based on the above exemplified format of the delay information subfield, a process of configuring the delay information subfield to carry the indicator parameter in S2115 includes S410 and S420 shown as follows:
S410: Determine an accumulated delay in a specified queue in the wireless device; and
S420: Configure a value of a delay valid subfield corresponding to the specified queue as 1, and configure a value of a queue delay field corresponding to the specified queue as the accumulated delay.

The accumulated delay in the specified queue in the wireless device may be determined according to processes as follows:
compute queuing time of each data packet in the specified queue according to arrival time of each data packet cached in the specified queue and current system time; and
sum queuing time of data packets in the specified queue, and obtain the accumulated delay.

In another exemplary embodiment, the operation of computing queuing time of each data packet in the specified queue according to arrival time of each data packet cached in the specified queue and current system time includes: obtain the queuing time of each data packet in the specified queue according to a difference between the current system time and the arrival time of each data packet cached in the specified queue.

If arrival time of an ith data packet cached in a specified queue is represented as t₀ⁱ, current system time is represented as t_{now}. In the embodiment, queuing time t₂ⁱ of the ith data packet in the specified queue may be computed according to a formula as follows:

$${t}_{2}^{i} = {t}_{now} - {t}_{0}^{i}$$

Queuing times of data packets in a specified queue is summed such that the accumulated delay in the specified queue in the wireless device can be obtained. In the wireless device, a number of data packets cached in a queue having a highest priority is generally the largest. Thus, in the embodiment, accumulated delays in all queues are not required to be computed, and only accumulated delays of a plurality of specified queues having highest priorities are required to be computed. For example, two queues having highest priorities are taken as specified queues. A number of specified queues is not limited herein.

Still with reference to FIG. 11 and FIG. 12, if a specified queue includes AC_VO, the AC_VO delay field is valid only when a value of the AC_VO delay valid subfield is 1. Moreover, a value of the AC_VO delay field may be set as an accumulated delay of the queue AC_VO. Similarly, if the specified queue includes AC_VI, the AC_VI delay field is valid only when a value of the AC_VI delay valid subfield is 1. Moreover, a value of the AC_VI delay field may be set as an accumulated delay of the queue AC_VI.

If the service data feature of the wireless device is irrelevant to the specified queue, for example, no service data cached in the specified queue exists in the wireless device, for example, no foregoing queue AC_VO or queue AC_VI exemplified exist in the wireless device, a value of the AC_VO delay valid subfield or a value of the AC_VI delay valid subfield is configured as 0, and the AC_VO delay field or the AC_VI delay field is configured as a null field.

In addition, with reference to FIG. 11, in another exemplary embodiment, the indicator parameter further includes a minimum life cycle of a data packet cached in the wireless device or a maximum queuing time of a queue. The delay info subfield further includes a delay bound field. The delay bound field may be referred to as a delay constraint field. The indicator parameter may be carried in the delay bound field. That is, the minimum life cycle or the maximum queuing time of the queue is set as a value of the delay bound field.

In the embodiment, the second indicator field is included in the broadcast TWT subfield. A value of the second indicator field is configured as 1. The delay info subfield is included at the end of the TWT parameter information field. The delay info subfield is configured such that indicator parameters for indicating first scheduling within the TWT SP may be carried. Thus, the wireless access point first schedules a current wireless device according to these indicator parameters.

FIG. 14 is a block diagram of a data transmission control apparatus according to an exemplary embodiment of this application. The data transmission control apparatus is configured on a wireless device for being connected to a wireless access point, for example, may be configured on a wireless device 10 in the implementation environment shown in FIG. 1.

As shown in FIG. 14, the data transmission control apparatus includes a transmitting module 1410 and a receiving module 1420. The transmitting module 1410 is configured to transmit a request frame carrying a TWT parameter to the wireless access point. The TWT parameter includes an indicator parameter for instructing the wireless access point to first schedule, within a TWT SP, the wireless device to perform data transmission. The receiving module 1420 is configured to receive a response frame returned by the wireless access point. The transmitting module 1410 is further configured to transmit, if the response frame indicates that the wireless access point already confirms the TWT parameter, a data packet to the wireless access point within the TWT SP.

In another exemplary embodiment, the transmitting module 1410 includes a carrying unit and a generating unit. The carrying unit is configured to carry the indicator parameter in a target wake time (TWT) element. The generating unit is configured to generate the request frame based on the TWT element, and transmit the request frame to the wireless access point.

In another exemplary embodiment, the carrying unit includes a first searching subunit and a first setting subunit. The first searching subunit is configured to search for a broadcast information subfield from a parameter information field included in the TWT element, and include a first indicator field in the broadcast information subfield. The first setting subunit is configured to configure a value of the first indicator field according to a service data feature of the wireless device, and take the value of the first indicator field as the indicator parameter.

In another exemplary embodiment, the first setting subunit includes a determining subunit, a first computing subunit, and a first configuring subunit. The determining subunit is configured to determine, according to the service data feature of the wireless device, a number of actively lost packets when the wireless device is unable to be scheduled by the wireless access point within the TWT SP. The first computing subunit is configured to compute a ratio of the number of the actively lost packets to a preset number. The first configuring subunit is configured to configure the value of the first indicator field as a first value if the ratio is greater than a preset maximum packet loss rate; or configure the value of the first indicator field as a second value if the ratio is less than or equal to the maximum packet loss rate.

In another exemplary embodiment, the determining subunit includes a second computing subunit, a third computing subunit, and a counting subunit. The second computing subunit is configured to compute, according to arrival time and life cycles of data packets cached in the wireless device, expected packet loss time of each data packet. The third computing subunit is configured to compute end time of the TWT SP. The counting subunit is configured to compute a total number of data packets of which the expected packet loss time is less than the end time, and take the total number of the data packets as the number of the actively lost packets.

In another exemplary embodiment, the second computing subunit is configured to compute a sum of the arrival time of each data packet and the life cycle of each data packet in the wireless device, and obtain the expected packet loss time of each data packet.

In another exemplary embodiment, the first setting subunit includes a determining subunit, a first computing subunit, and a second configuring subunit. The determining subunit is configured to determine, according to the service data feature of the wireless device, a number of actively lost packets when the wireless device is unable to be scheduled by the wireless access point within the TWT SP. The first computing subunit is configured to compute a ratio of the number of the actively lost packets to a preset number. The second configuring subunit is configured to configure the value of the first indicator field according to the ratio. Different values of the first indicator field represent different first scheduling levels.

In another exemplary embodiment, the second configuring subunit is specifically configured to implement processes as follows: configure the value of the first indicator field as a third value if the ratio is less than a preset first packet loss rate; configure the value of the first indicator field as a fourth value if the ratio is greater than the first packet loss rate and less than a preset second packet loss rate; configure the value of the first indicator field as a fifth value if the ratio is greater than the second packet loss rate and less than a preset third packet loss rate; or configure the value of the first indicator field as a sixth value if the ratio is greater than the third packet loss rate.

In another exemplary embodiment, the carrying unit includes a second searching subunit, a second setting subunit, and a third configuring subunit. The second searching subunit is configured to search for a broadcast information subfield from a parameter information field included in the TWT element, and include, in the broadcast information subfield, a second indicator field for indicating that delay information is included. The second setting subunit is configured to configure a value of the second indicator field as 1, and include a delay information subfield in the parameter information field. The third configuring subunit is configured to configure the delay information subfield, and carry the indicator parameter.

In another exemplary embodiment, the delay information subfield includes a delay information control field and a queue delay field. The delay information control field includes a delay valid subfield for defining validity of the queue delay field. The third configuring subunit is configured to determine an accumulated delay in a specified queue in the wireless device, configure a value of a delay valid subfield corresponding to the specified queue as 1, and configure a value of a queue delay field corresponding to the specified queue as the accumulated delay.

In another exemplary embodiment, the third configuring subunit is further configured to configure, if the service data feature of the wireless device is irrelevant to the specified queue, the value of the delay valid subfield corresponding to the specified queue as 0, and configure the queue delay field corresponding to the specified queue as a null field.

In another exemplary embodiment, the third configuring subunit is configured to compute, according to arrival time of each data packet cached in a specified queue and a current system time, queuing time of each data packet in the specified queue, sum queuing time of data packets in the specified queue, and obtain an accumulated delay.

In another exemplary embodiment, the third configuring subunit is configured to obtain the queuing time of each data packet in the specified queue according to a difference between the current system time and the arrival time of each data packet cached in the specified queue.

In another exemplary embodiment, the delay information subfield includes a delay constraint field. The carrying unit further includes a constraint subunit. The constraint subunit is configured to determine a minimum life cycle of a data packet cached in the wireless device or a maximum queuing time of a queue, and configure the minimum life cycle or the maximum queuing time of the queue as a value of the delay constraint field.

In another exemplary embodiment, the delay information subfield carries a delay processing parameter. Reference information for determining whether to first schedule the wireless device within the TWT SP is transmitted to the wireless access point by using the delay processing parameter. Thus, whether to first schedule the wireless device is determined by the wireless access point based on the reference information carried in the request frame.

In another exemplary embodiment, the transmitting module 1410 further includes a determining unit and a transmitting unit. The determining unit is configured to determine, according to a service data feature of the wireless device, whether the data packet is to be lost due to a timeout. The service data feature is information for describing a feature of data related to a service in the wireless device. The transmitting unit is configured to transmit, if a determination result indicates that the data packet is to be lost due to a timeout, the request frame carrying the TWT parameter to the wireless access point.

In another exemplary embodiment, the carrying unit is further configured to determine, according to the service data feature, a level at which first scheduling is required to be performed, and carry the level of the first scheduling to the request frame as the indicator parameter for instructing the wireless access point to first schedule the wireless device.

The data transmission control apparatus provided in the above embodiment and the data transmission control method provided in the above embodiment belong to the same concept. Specific methods of performing operations by each module and unit are described in detail in the method embodiment, and will not be repeated herein. During practical application, the data transmission control apparatus provided in the above embodiment can allocate the above functions to different function modules for implementation according to requirements. That is, the internal structure of the apparatus is divided into different function modules to complete all or some of the functions mentioned above, which is not limited herein.

The data transmission control apparatus provided in embodiments of this application is arranged, a wireless device instructs, by using a signaling, a wireless access point to first schedule uplink data of the wireless device. That is, when a response frame received by the wireless device indicates that the wireless access point already confirms a TWT parameter carried in a request frame transmitted by the wireless device, the wireless access point already confirms that the wireless device is first scheduled within a TWT SP expected by the wireless device. Thus, the wireless device can transmit a data packet in time within the TWT SP such that a problem that the data packet is lost due to a timeout can be avoided, and quality of service of a low-delay service can be improved.

An embodiment of this application further provides an electronic device. The electronic device includes: one or more processors; and a memory configured to store one or more programs. The one or more computer programs cause the electronic device to implement the data transmission control method provided in various embodiments mentioned above when executed by the one or more processors.

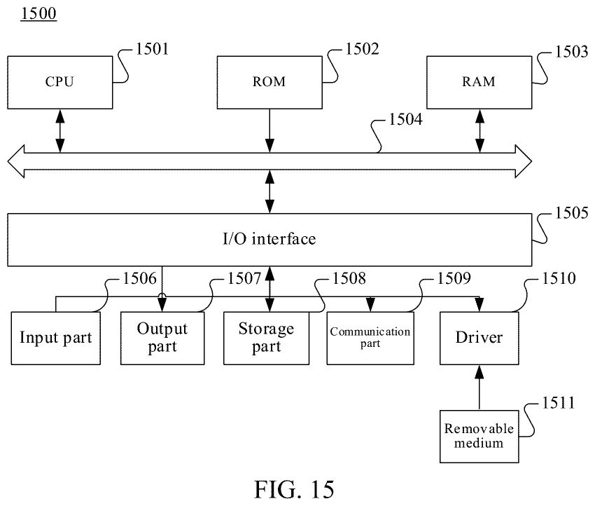

FIG. 15 is a schematic structural diagram of a computer system suitable for implementing an electronic device according to an embodiment of this application. The computer system 1500 of the electronic device shown in FIG. 15 is merely an example, and is not to constitute any limitation to functions and use ranges of embodiments of this application.

As shown in FIG. 15, the computer system 1500 includes a central processing unit (CPU) 1501, which may perform various suitable actions and processing according to a program stored in a read-only memory (ROM) 1502 or a program loaded from a storage part 1508 into a random access memory (RAM) 1503, for example, perform the method in the above embodiment. Various programs and data required for system operations are further stored in the RAM 1503. The CPU 1501, the ROM 1502, and the RAM 1503 are connected to each other by a bus 1504. An input/output (I/O) interface 1505 is also connected to the bus 1504.

The following components are connected to the I/O interface 1505: an input part 1506 including a keyboard, a mouse, etc.; an output part 1507 including a cathode ray tube (CRT), a liquid crystal display (LCD), a speaker, etc.; a storage part 1508 including a hard disk, etc.; and a communication part 1509 including a network interface card such as a local area network (LAN) card and a modem. The communication part 1509 performs communication processing by using a network such as the Internet. A driver 1510 is also connected to the I/O interface 1505 according to requirements. A removable medium 1511, such as a magnetic disk, an optical disc, a magneto-optical disk, and a semiconductor memory, is mounted on the driver 1510 according to requirements, such that a computer program read from the removable medium is mounted into the storage part 1508 according to requirements.

Particularly, according to embodiments of this application, the processes described above with reference to the flowcharts may be implemented as computer software programs. For example, an embodiment of this application includes a computer program product. The computer program product includes a computer program stored in a computer-readable medium. The computer program includes a computer program for performing a method shown in the flowchart. In such an embodiment, the computer program may be downloaded and mounted from a network by the communication part 1509, and/or mounted from the removable medium 1511. When executed by the central processing unit (CPU) 1501, the computer program executes various functions defined in the system in this application.

The computer-readable medium shown in an embodiment of this application may be a computer-readable signal medium, a computer-readable storage medium, or any combinations of the foregoing. The computer-readable storage medium may be an electronic, magnetic, optical, electromagnetic, infrared, or semiconductor system, apparatus, or device, or any combinations of the foregoing. A more specific example of the computer-readable storage medium may include but is not limited to: an electrical connection having one or more wires, a portable computer disk, a hard disk, a random access memory (RAM), a read-only memory (ROM), an erasable programmable read only memory (EPROM), a flash memory, an optical fiber, a portable compact disk read-only memory (CD-ROM), an optical storage device, a magnetic storage device, or any suitable combinations of the foregoing. In this application, the computer-readable signal medium may include a data signal transmitted in a baseband or as a part of a carrier, and stores a computer-readable computer program. A data signal propagated in such a way may have a plurality of forms including but not limited to an electromagnetic signal, an optical signal, or any suitable combinations of the foregoing. The computer-readable signal medium may be any computer-readable medium in addition to a computer-readable storage medium. The computer-readable medium may transmit, propagate, or transfer a program that is used by or used in conjunction with an instruction execution system, apparatus, or device. The computer program included in the computer-readable medium may be transmitted by using any suitable media including but not limited to: a wireless medium, a wired medium, or any suitable combinations of the foregoing.

The flowcharts and block diagrams in the accompanying drawings illustrate system architectures, functions, and operations that may be implemented by a system, a method, and a computer program product according to various embodiments of this application. Each block in flowcharts or block diagrams can represent a module, a program segment, or a part of a code, which include one or more executable instructions for implementing specified logical functions. In some substitutive implementations, functions noted in blocks can also occur in sequences different from those noted in the figures. For example, two continuous blocks may be executed substantially in parallel in practice, and sometimes implemented in reverse sequences, which depends on the involved functions. Each block in flowcharts and/or block diagrams, and combinations of the blocks in the flowcharts and/or the block diagrams, may be implemented by dedicated hardware-based systems that execute specified functions or operations, or may be implemented by combinations of dedicated hardware and computer instructions.

An involved unit described in embodiments of this application may be implemented in a form of software, or may be implemented in a form of hardware. The unit described may be arranged in a processor. Names of these units do not constitute limitations to the units in a specific situation.

Another aspect of this application further provides a computer-readable storage medium. The computer-readable storage medium has a computer program stored therein. When executed by a processor, the computer program implements the data transmission control method mentioned above. The computer-readable storage medium may be included in the electronic device described in the above embodiments, or may exist alone without being arranged in the electronic device.

Another aspect of this application further provides a computer program product or a computer program. The computer program product or the computer program includes a computer instruction. The computer instruction is stored in a computer-readable storage medium. A processor of a computer device reads a computer instruction from a computer-readable storage medium. The processor executes the computer instruction to cause the computer device to perform the data transmission control method provided in various embodiments mentioned above.

The above content is merely preferred exemplary embodiments of this application, and is not intended to limit implementation solutions of this application. A person of ordinary skill in the art can extremely easily make corresponding changes or modifications according to the main concept of this application. Thus, the scope of protection of this application is subject to the scope of protection claimed in the claims.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module can be part of an overall module that includes the functionalities of the module. In particular implementations of this application, related data of a data packet, a request frame, a response frame, an indicator parameter, etc. are involved. When the above embodiments of this application are applied to a specific product or technology, a permission or consent of a user is required. Moreover, collection, use, and processing of the related data need to comply with related laws, regulations, and standards of related countries and regions.

What is claimed is:

1. A data transmission control method performed by a computer device that is wirelessly connected to a wireless access point, comprising:
transmitting, to the wireless access point, a request frame carrying a target wake time (TWT) parameter, the TWT parameter comprising an indicator parameter for instructing the wireless access point to schedule the computer device to perform data transmission within a target wake time service period (TWT SP);
receiving a response frame returned by the wireless access point; and
transmitting, when the response frame indicates that the wireless access point confirms the TWT parameter, a data packet to the wireless access point within the TWT SP.

2. The method according to claim 1, wherein the transmitting, to the wireless access point, a request frame carrying a target wake time (TWT) parameter comprises:
carrying the indicator parameter in a target wake time (TWT) element; and
generating the request frame based on the TWT element, and transmitting the request frame to the wireless access point.

3. The method according to claim 2, wherein the carrying the indicator parameter in a target wake time (TWT) element comprises:
searching for a broadcast information subfield from a parameter information field comprised in the TWT element, and the broadcast information subfield comprising a first indicator field; and
configuring a value of the first indicator field according to a service data feature of the computer device as the indicator parameter.

4. The method according to claim 3, wherein the configuring a value of the first indicator field according to a service data feature of the wireless device comprises:
determining, according to the service data feature of the wireless device, a number of actively lost packets when the wireless access point cannot schedule the computer device within the TWT SP;
computing a ratio of the number of the actively lost packets to a preset number;
configuring the value of the first indicator field as a first value when the ratio is greater than a preset maximum packet loss rate; and
configuring the value of the first indicator field as a second value when the ratio is less than or equal to the preset maximum packet loss rate.

5. The method according to claim 4, wherein the determining, according to the service data feature of the wireless device, a number of actively lost packets when the wireless access point cannot schedule the computer device within the TWT SP comprises:
computing, according to arrival time and life cycles of data packets arriving at the computer device, expected packet loss time of each data packet; and
computing end time of the TWT SP; and
computing a total number of data packets of which expected packet loss time is less than the end time of the TWT SP as the number of the actively lost packets.

6. The method according to claim 5, wherein the computing, according to arrival time and life cycles of data packets arriving at the computer device, expected packet loss time of each data packet comprises:
computing a sum of the arrival time of each data packet and the life cycle of each data packet arriving at the wireless device, and obtaining the expected packet loss time of each data packet.

7. The method according to claim 3, wherein the configuring a value of the first indicator field according to a service data feature of the computer device as the indicator parameter comprises:
determining, according to the service data feature of the wireless device, a number of actively lost packets when the wireless access point cannot schedule the computer device within the TWT SP;
computing a ratio of the number of the actively lost packets to a preset number; and
configuring the value of the first indicator field according to the ratio, wherein different values of the first indicator field represents different first scheduling levels.

8. The method according to claim 7, wherein the configuring the value of the first indicator field according to the ratio comprises:
configuring the value of the first indicator field as a third value when the ratio is less than a preset first packet loss rate;
configuring the value of the first indicator field as a fourth value when the ratio is greater than the first packet loss rate and less than a preset second packet loss rate;
configuring the value of the first indicator field as a fifth value when the ratio is greater than the second packet loss rate and less than a preset third packet loss rate; and
configuring the value of the first indicator field as a sixth value when the ratio is greater than the third packet loss rate.

9. The method according to claim 2, wherein the carrying the indicator parameter in a target wake time (TWT) element comprises:
searching for a broadcast information subfield from a parameter information field comprised in the TWT element, and the broadcast information subfield comprising a second indicator field for indicating that delay information is carried and the parameter information field further comprising a delay information subfield;
configuring a value of the second indicator field as 1; and
configuring the delay information subfield, and carrying the indicator parameter.

10. The method according to claim 9, wherein the delay information subfield comprises a delay information control field and a queue delay field, and the delay information control field comprises a delay valid subfield for defining validity of the queue delay field; and
the configuring the delay information subfield, and carrying the indicator parameter comprise:
determining an accumulated delay in a specified queue in the wireless device; and
configuring a value of a delay valid subfield corresponding to the specified queue as 1, and configuring a value of a queue delay field corresponding to the specified queue as the accumulated delay.

11. The method according to claim 10, further comprising:
configuring, when the service data feature of the wireless device is irrelevant to the specified queue, the value of the delay valid subfield corresponding to the specified queue as 0, and configuring the queue delay field corresponding to the specified queue as a null field.

12. The method according to claim 10, wherein the determining an accumulated delay in a specified queue in the wireless device comprises:
computing queuing time of each data packet in the specified queue according to arrival time of each data packet cached in the specified queue and current system time; and
summing queuing time of data packets in the specified queue, and obtaining the accumulated delay.

13. The method according to claim 12, wherein the computing queuing time of each data packet in the specified queue according to arrival time of each data packet cached in the specified queue and current system time comprises:
obtaining the queuing time of each data packet in the specified queue according to a difference between the current system time and the arrival time of each data packet cached in the specified queue.

14. The method according to claim 9, wherein the delay information subfield comprises a delay constraint field; and the method further comprises:
determining a minimum life cycle of a data packet cached in the wireless device or maximum queuing time of a queue; and
configuring the minimum life cycle or the maximum queuing time of the queue as a value of the delay constraint field.

15. The method according to claim 9, wherein the delay information subfield carries a delay processing parameter, such that reference information for determining whether to schedule the computer device within the TWT SP is transmitted to the wireless access point by using the delay processing parameter, and whether to first schedule the computer device is determined by the wireless access point based on the reference information carried in the request frame.

16. The method according to claim 1, wherein before the transmitting, to the wireless access point, a request frame carrying a target wake time (TWT) parameter, the method further comprises:
determining, according to a service data feature of the computer device, whether the data packet is to be lost due to a timeout, the service data feature being information for describing a feature of data related to a service in the computer device; and
transmitting, when a determination result indicates that the data packet is to be lost due to a timeout, the request frame carrying the TWT parameter to the wireless access point.

17. The method according to claim 16, further comprising:
determining, according to the service data feature, a level at which first scheduling is required to be performed, and carrying the level of the first scheduling to the request frame as the indicator parameter for instructing the wireless access point to first schedule the computer device.

18. A computer device, comprising:
one or more processors; and
a memory configured to store one or more programs, the one or more computer programs, when executed by the one or more processors, causing the computer device to implement a data transmission control method including:
transmitting, to the wireless access point, a request frame carrying a target wake time (TWT) parameter, the TWT parameter comprising an indicator parameter for instructing the wireless access point to schedule the computer device to perform data transmission within a target wake time service period (TWT SP);
receiving a response frame returned by the wireless access point; and
transmitting, when the response frame indicates that the wireless access point confirms the TWT parameter, a data packet to the wireless access point within the TWT SP.

19. The computer device according to claim 18, wherein before the transmitting, to the wireless access point, a request frame carrying a target wake time (TWT) parameter, the method further comprises:
determining, according to a service data feature of the computer device, whether the data packet is to be lost due to a timeout, the service data feature being information for describing a feature of data related to a service in the computer device; and
transmitting, when a determination result indicates that the data packet is to be lost due to a timeout, the request frame carrying the TWT parameter to the wireless access point.

20. A non-transitory computer-readable storage medium, having a computer-readable instruction stored therein, the computer-readable instruction, when executed by a processor of a computer device, causing the computer device to implement a data transmission control method including:
transmitting, to the wireless access point, a request frame carrying a target wake time (TWT) parameter, the TWT parameter comprising an indicator parameter for instructing the wireless access point to schedule the computer device to perform data transmission within a target wake time service period (TWT SP);
receiving a response frame returned by the wireless access point; and
transmitting, when the response frame indicates that the wireless access point confirms the TWT parameter, a data packet to the wireless access point within the TWT SP.
